(19) United States
(12) Patent Application Publication
(10) Pub. No.: US 2012/0244412 A1
(43) Pub. Date: Sep. 27, 2012

(54) PERFORATED FILM

(75) Inventors: Matthias Pascaly, Frankfurt (DE); Michael Kube, Haltern am See (DE); Michael Olbrich, Karlstein (DE)

(73) Assignee: Evonik Degussa GmbH, Essen (DE)

(21) Appl. No.: 13/512,950

(22) PCT Filed: Nov. 4, 2010
(86) PCT No.: PCT/EP2010/066798

§ 371 Date: May 31, 2012

(30) Foreign Application Priority Data
Dec. 3, 2009 (DE) 10 2009 047 440.4
Feb. 9, 2010 (DE) 10 2010 001 702.7

(51) Int. Cl. B32B 3/10; H01M 2/16

(52) U.S. Cl. 429/144; 428/131; 428/138; 429/247

(57) ABSTRACT

The invention relates to a perforated film that has a thickness of less than 20 μm, a tensile strength of 2 N/cm to 40 N/cm, and a perforated surface area of 10% to 90%.

### FIELD OF THE INVENTION

The invention relates to the construction and the properties of thin, perforated films, and more particularly films having large open areas, which demonstrate an adequate stability to withstand subsequent processing operations, such as the application of a coating or of adhesive, for example.

### BACKGROUND TO THE INVENTION

Porous films, including microperforated films, are well known and a variety of uses and methods of manufacture have been found for these materials. Uses described include battery separators, filters, air-permeable, flexible packaging, components of wound dressings, and air-permeable membranes for use in clothing. Manufacturing methods include, for example, those appraised in “A review on the separators of liquid electrolyte Li-ion batteries”, Journal of Power Sources, 164, (2007), 351-64. These methods include the so-called dry and wet processes, phase inversion, and thermally induced liquid-liquid phase separation. This appraisal also describes how membranes, including perforated polymeric films manufactured for use as battery separators, can be modified in a subsequent coating process in order to modify and to enhance their properties in respect, for example, of wettability or interfacial contact between the separator and the electrodes.

Other manufacturing methods include the formation of voids in films by a variety of perforation processes, including needle punching, electrostatic discharge, treatment with high-energy particles, point application of reduced pressure, and laser perforation.

Laser perforation has certain advantages in the mass manufacture of porous films:
1. It is a noncontact method—a particular advantage when thin or ultrathin films are being perforated, where a contact process such as needle punching entails the risk of film tearing.
2. It is possible to deliver very high energies to the regions to be perforated, thus permitting very short perforation times.
3. It permits attainment of reproducible and controllable hole dimensions.
4. Through the use of appropriate optical systems to permit the laser beam to be directed onto specific points on the surface of the film, it is possible to achieve a regular and reproducible two-dimensional hole pattern within the film.

Thus U.S. Pat. No. 7,083,837 A describes a method for perforating polymeric film webs by means of a CO₂ laser. In one option the web is unwound and then stopped while the laser beam perforates a defined two-dimensional area, the movement of the beam being steered by a galvanometric scanner. Alternatively a moving web is perforated by a stationary laser beam or beams to create a series of perforated tracks in the machine direction of the film. It is apparent, however, that for this kind of methods for perforating moving webs of a film in a reel-to-reel process there are different limitations. In particular, this method does not afford a practical solution to the continuous perforation of the entire film surface, or a considerable proportion of the entire film surface, in order to obtain porous films having significant open areas and hole densities. Severe limitations are imposed by the speed of lateral displacement that is possible for a single laser beam when it is required to move over the transverse direction of the film web and to create a plurality of perforations. Consequently, the maximum possible web speeds fall significantly below an economically viable threshold for the majority of applications, even if use of a system with multiple lasers is contemplated.

Another example of a laser perforation method is provided by EP 0 953 399 A. Here, a single laser beam is directed onto points on a moving film web by small mirrors, mounted on the periphery of a drum, which is rotated above the surface of the film. Hole formation occurs by an ablation process. Hole diameters of approximately 200 μm are claimed for an excimer laser process. The principal objective, however, is to achieve relatively large holes, and examples of holes having a diameter of 5.05 mm are mentioned. For this method, the maximum hole resolution is limited by the number of mirrors which can be located on the drum, and by the minimum hole diameter which can be achieved.

Porous films are characterized typically by a number of parameters, including the hole diameter and the hole shape, the hole pattern, the total open area (porosity), the material, the film thickness, the tensile strength, and the elasticity modulus.

There is a wide variety of publications which describe thin, microperforated, polymeric films. As an example, JP 2006-6326860 A describes microperforated, polymeric films having thicknesses in the range from 1 to 25 μm and having an open area of more than 10%. JP A 06100720 describes porous polypropylene films having tensile strengths in the range of 60-150 N/mm².

JP 10-330521 A describes polyolefin films of high tensile strength which have a thickness in the range of 10-120 μm and are manufactured by needle or laser perforation, with a tensile strength of up to 10 kg/5 cm=20 N/cm.

DE 196 47 543 C describes a thin, perforated film web as packaging material such as a stretch film, the holes in which open on application of a tensile stress; the tensile stress is not addressed in any more detail.

WO 2008/102140 describes a process for perforating film webs by laser. The properties of the perforated films obtained, however, are not described. Nor are there any examples of a free-standing film whose tensile strength is determined by a microindentation method with a porous coating on the substrate material.

In spite of the fact that thin, porous, polymeric films have been described in the prior art and that various minimum values (e.g., tensile strength, thickness, porosity, hole diameter) have been specified or can be calculated, it appears that no attention has been paid to the requirements for achieving and for processing stable, thin, porous films. More particularly there is no information about the stability necessary in order to withstand a subsequent coating process, and the consequent requirement to achieve a minimum tensile strength; nor have any thin films been provided which meet these needs.

### SUMMARY OF THE INVENTION

The present invention relates to the manufacture and the properties of thin, perforated films which have sufficient stability to withstand subsequent processes, such as a coating or impregnating process, for example.

In the context of the present invention, the tensile strength of the film of the invention is reported in N/cm as a product obtained from the measurement obtained with the tensile-strength tester and the thickness of the perforated film.

According to the present invention, a perforated film is provided which has a thickness of less than 20 μm, a tensile strength of 2 N/cm to 40 N/cm, and a hole area of 10% to 90% of an equivalent unperforated film.

At this point and below, hole area refers to the ratio of the area occupied by the holes, abbreviated to areaₕₒₗₑ, to the area occupied by the unperforated film, synonymous with the film present prior to perforation, and abbreviated to area_{film}, in percent:

hole area=(areaₕₒₗₑ/area_{film})*100%.

The tensile strength is defined in a way which is known to the skilled person, in accordance with ASTM 882.

Further embodiments of the present invention include a process for manufacturing a perforated film of the above-described type, a coated perforated film, various uses of the optionally coated or impregnated perforated film, including its use as a battery separator, air-permeable packaging material, electrochemical membrane, and disposable filter medium, and laminates of the optionally coated perforated film.

### DETAILED DESCRIPTION OF THE INVENTION

Films according to the present invention may comprise any type of film which can be manufactured with a thickness of less than 20 μm, preferably up to 15 μm, more preferably up to 12 μm, even more preferably 10 μm or less, and most preferably 5 μm or less. A preferred lower limit to the thickness of film according to the present invention is around 1 μm.

The film of the invention may have a weight of 40% to 100% of the weight of the equivalent unperforated film.

Metal foils whose material is selected from Si, Al, Cu, Fe, or steels customary in the art, or thermoplastic films amenable to perforation by a laser, are preferred, including, but not limited to, polyester films. Examples of suitable thermoplastic materials include polyethylene (PE), polypropylene (PP), polyethylene glycol terephthalate (PET), polyethylene glycol naphthenate (PEN), polylactic acid (PLA), polyacrylonitrile (PAN), polyamides (PA), aromatic polyamides (Ar), polymethyl methacrylate (PMMA), polyimide (PI), and copolymers thereof, films with polyester copolymers and polyester mixtures, which have been described as components of digital stencils for use in digital copier printing processes. PET and PEN are preferred, and PET is most preferred.

Other suitable polymers for use in the films of the present invention include polyolefins such as, for example, polyamides, polyacrylonitrile, polyimides, fluorinated polymers such as, for example, polyvinylidene fluoride, polystryene, polycarbonate, acrylonitrile-butadiene-styrene, and cellulose esters.

Additionally suitable are polyesters selected from polyester film or polyamide, preferably polyamide 6.6, polyamide 12, or polyamide 6.

The film may comprise a polymer, and it may also comprise additional components such as, for example, plasticizers, mineral particles, waxes, dyes, slip agents, release or antistick agents, and any other additives known from the prior art. Additives of these kinds are capable of modifying the functionality or the appearance of the film, with consequences for properties such as, for example, stiffness, tensile strength, blocking, slip, gloss, opacity, surface roughness, surface and volume conductivity, and color.

In one particular embodiment the base film, i.e., the film prior to perforation, may comprise a pigment or a dye which at an appropriate wavelength absorbs laser energy, in order to allow or enhance perforation by means of a laser or another form of radiation.

For the preferred laser perforation process using a semiconductor laser arrangement, the added pigment or dye increases the absorption of light at the operating wavelength of the laser. Semiconductor lasers typically operate in the near infrared region of the electromagnetic spectrum, in a range from 690 to 1500 nm. For certain product applications it is important to select materials which have minimal effect on film opacity or film color.

The base film may also comprise a coating or ink. The coating or ink may be located on only one or both film surfaces. The coating or ink may occupy the entirety or any part of the film surfaces. In one particular embodiment the coating or ink has the property of absorbing energy emitted by the laser used for the perforation process, so that by pattern printing of the film surface, perforation occurs only in the printed regions. The pattern may comprise a block area which will be perforated with a plurality of holes. Alternatively the pattern may comprise a set of dots which each define the position and size of an individual perforation. The coating or ink may include additives of the above-described type as additive components of the polymeric film, and also other components, such as, for example, resins, surfactants, viscosity modifiers, flow aids, adhesion promoters, biocides and other coating components known from the prior art.

In an embodiment in which the coating comprises a dye or pigment to absorb energy in the near infrared, carbon is a preferred pigment for certain applications, on account of its ease of incorporation, its low costs, and its broad absorption over the entire spectral range. For some applications, though, it is necessary to use alternative materials, in order to minimize the effect of the coating on the color and opacity of the film material.

The coating may be applied from an organic solvent or from a water-based vehicle. Alternatively it may be applied as a coating with 100% solids, which is subsequently cured by irradiation with UV light or with an electron beam source. Any known printing or coating method may be used to apply the coating, including slot die, gravure, roller, and curtain coating methods. Preferred printing processes include offset, stamping, screenprinting, flexographic printing, gravure printing, and rotary film printing processes, but may also include other processes, such as intaglio or letterpress methods and nonmechanical processes such as inkjet printing, for example.

The perforated films of the present invention typically have perforations or holes with an average (i.e., mean) diameter in the range from 50 to 250 μm, preferably 51 to 150 μm, more preferably 52 to 125 μm. In connection with the present invention, the average diameter is the average of the maximum and minimum diameters of a perforation, as determined by optical or scanning electron microscopy (SEM). For some applications it is preferred for the perforations to have substantially the same size, which varies in average diameter by, for example, only up to 10% or less.

The film of the invention may have perforations each of which has a raised margin at its periphery, which has a greater thickness than the film at its unperforated region.

Furthermore, in the film, a material which absorbs in the near infrared may be present in the raised margins of the perforations, but absent from regions between the perforations.

In regions having continuous perforation, high open regions (or porosities) are possible. The majority of pore creation processes produce circular or substantially circular holes. Here, the maximum open area is a function of the maximum hole packing density which is achievable for that shape. In one novel embodiment, however, it is possible to create holes having any shape in accordance with the form of a printed precursor dot which is capable of absorbing energy from a perforating laser source. The invention is not confined, for example, to the creation of circular or oval holes, but instead extends to a broad range of other geometric shapes, including polygons such as hexagons, for example. On account of the more efficient packing densities which can therefore be achieved, very high porosities of up to 90% open area are possible, subject to the proviso that the resultant film meets the requirement for a minimum tensile strength of 2 N/cm. In connection with the present invention, the phrase “a continuous perforation area” means an area in which the maximum distance between the centers of adjacent holes is less than or equal to twenty times the average diameter of the holes. Using the perforation methods described herein it is typically possible to achieve holes with a resolution of 30 to 700 holes per inch.

Through the present invention it is also possible to create holes having substantially different diameters in the same piece of film, if this is necessary for the intended end application of the film.

An additional way of quantifying the degree of perforation in the thin films of the present invention is to consider the total solid—i.e., polymeric or metallic—cross-sectional area of the film which remains both in the machine direction and transverse direction after the perforation process. The cross-sectional area is determined by subtracting the cross-sectional area occupied by pores or perforations from the overall cross-sectional area of the film prior to perforation. The cross-sectional area occupied by the pores or perforations can be determined by optical or scanning electron microscopy. The overall cross-sectional area is within a range from 95% to 10%, preferably 90% to 30%, of an equivalent unperforated film.

Another way of quantifying the degree of perforation starts from the weight of the film which remains after perforation, in comparison to an equivalent unperforated film. The weight of the perforated film of the present invention is preferably from 20 to 100% of the weight of an equivalent unperforated film or equal to the weight of a discrete perforated area of the film of greater than or equal to 20% and up to 100% of an equivalent discrete area of the film which has not been perforated. This amount of weight retention is typically achieved by a melting process to form the perforations, rather than by an ablation process.

In a melting process, in particular, a consequent increase in film thickness occurs at the hole margin, forming what is referred to in the context of the present invention as a “raised margin”. The increase in film thickness at the perforation margin is critically dependent on the thickness of the precursor film or on the combined thickness of the film and any coating applied to it, together with the diameter of the perforation created. We have observed cases in which the perforation margins bring about an increase in film thickness of more than 95%. The increase in film thickness can be measured by a mechanical means such as a dial gauge. Alternatively it is possible to use measurements derived through the analysis of images which are generated by scanning electron microscopy.

For some downstream operations such as printing, for example, it is preferred for the raised surfaces caused by the raised perforation margin to be disposed only on one film surface, leaving the other surface relatively smooth. Films with this kind of structure can be achieved when they are perforated with a semiconductor laser arrangement.

Ultimately, the degree of perforation is dependent on the intended end use of the perforated film of the present invention.

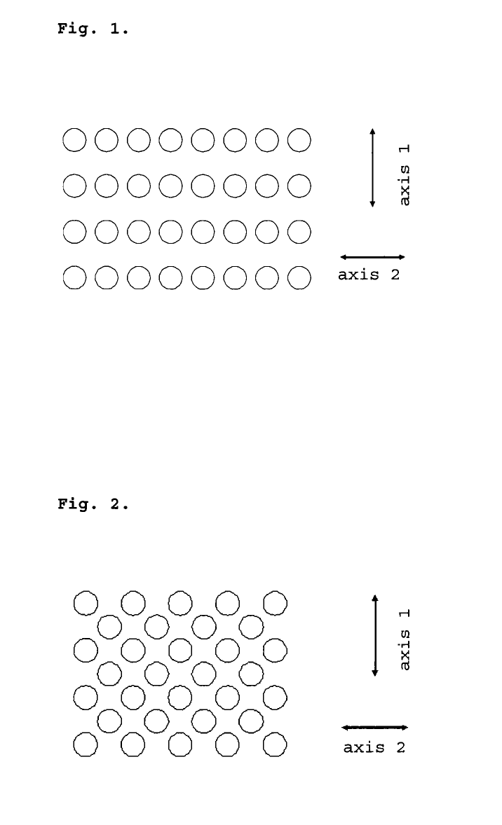

The perforation pattern may contribute significantly to the physical properties of the perforated films of the invention, with consequences for properties such as tensile strength and tensile modulus, for example. Consideration of these effects is particularly important when thin films having relatively high open areas are created. A perforation structure which has a series of parallel perforations, as shown in FIG. 1, exhibits a significantly lower tensile strength in the axis 1 than a hole pattern in which the holes are offset in alternating rows, as shown in FIG. 2, since the minimum cross-sectional area on which these properties depend is significantly greater in the case of FIG. 2.

A particular advantage of the present invention is that thin, perforated films are created which have sufficient stability to withstand a further process such as coating, impregnation or lamination, for example. Coating and impregnation processes entail the application of a liquid medium to the perforated film and its subsequent drying and/or curing, in order to carry out a crosslinking or polymerization reaction, as for example by application of heat or irradiation with UV light or an electron beam. Impregnation processes achieve penetration of the perforated film with the impregnating material, meaning that this material is present within the pores of the perforated film. In some cases the impregnating material may entirely encapsulate or enclose the film. During the implementation of the drying and/or curing steps, the applied coating or the impregnating material undergoes shrinkage.

Below, where the present invention is described in relation to coated, perforated films, unless otherwise stated, the same or similar considerations apply to impregnated perforated films, in terms for example of the materials used for impregnation and the end applications of the films.

The factors which determine the tensile strength of a microperforated film are the material of the film and the conditions of the film manufacture, together with the minimum cross-sectional area of the film. The latter parameter relates in turn to the film thickness and to the perforation properties (open area and perforation pattern).

We have found that the thin, perforated films of the present invention must have a tensile strength of at least 2 N/cm in order to exhibit sufficient processability when a coating is applied to them. The tensile strength is preferably from 5 N/cm to 20 N/cm and more preferably from 10 N/cm to 20 N/cm.

Although films are obtainable that allow the manufacture of perforated films having a thickness of less than 20 μm and more particularly 12 μm or less, there are circumstances, for the purpose of meeting the specific tensile strength value, in which this might not be possible with a film per se. The tensile strength of the given film prior to perforation, referred to as precursor film in the context of the present invention, may, for example, prevent the attainment of the required specified value for tensile strength after perforation. In other cases, the requirement to achieve the specified value is detrimental to the commercial profitability of the perforated film, since it requires the use of a thicker film than is desired. Here, the deleterious effect might arise from the increased costs of the precursor film or from the increased costs of the perforation process—for example, because the perforation rate is reduced. Under these circumstances, one possible counter-measure involves incorporating the otherwise unacceptably thin film into a laminate with a porous medium such as a nonwoven material, for example, which has a property of improving the tensile strength in comparison to the film alone.

The present invention therefore also provides a laminate which comprises a perforated film of the invention and a porous medium to which the film of the invention is laminated, the laminate having a tensile strength of 2 to 50 N/cm.

The typical porous medium may be a nonwoven; it includes tissue paper and another porous medium with long cellulose fibers, such as manilla fibers, synthetic polymer fibers, and microfibers, for example, and mixtures thereof.

Typical thicknesses of such porous media are in the range from 15 to 60 μm. It is important that the porous medium which is laminated on the perforated film does not impair its performance. Consequently, it is desirable for the void sizes in the porous medium to be larger than the size of the pores in the perforated film, and for any laminating adhesive used not to block the pores in both components of the laminate. The selection of suitable materials would be routine for those skilled in the art.

Optionally, the porous medium may be removable from the laminate after the perforation of the film or after the coating or impregnating of the perforated film. For this removal purpose, the film and/or the porous medium may be provided with a release coating, using any of the conventional materials that are used for this purpose in the field of art.

The film itself may have a thickness of less than 20 μm and a hole area as described above in relation to the stand alone film. Typically, however, lamination would be most beneficial with films at the lower end of this thickness range.

The perforated film of the laminate of the invention may preferably comprise or consist of a thermoplastic polymer. With particular preference this polymer may be selected from polyester, polyethylene terephthalate, polyethylene naphthenate, or polyamide, preferably polyamide 6.6, polyamide 12, or polyamide 6.

It may additionally be advantageous if in the laminate of the invention

a) the perforated film has a lower melting point than the porous medium, and this melting point is not more than 250° C.,
or
b) the porous medium has a lower melting point than the perforated polymeric film, and this melting point is not more than 250° C.

Lamination may be performed before or after perforation of the film.

Films according to the present invention or for inclusion in the laminates of the present invention may be created by any known perforation process. Noncontact methods, including laser perforation, or perforation by other forms of radiation, are preferred. For some applications, however, a contact process, an example being the use of a thermal printing head, may be advantageous. Other methods include needle punching or diecutting.

If a thermal printing head is used as a means of perforation, the unperforated film is moved over the head at a rate which allows sufficient thermal energy to be transferred into the film to allow perforation to take place. During this process, individual point heaters on the thermal printing head are switched on and off by a head driver in order to deliver energy pulses to the film. For this process it is desirable for the film to have an antistick coating on the head contact side. Additionally it is necessary to bear in mind the energy of the thermal printing head in conjunction with the thickness and thermal shrinkage properties of the film, in order to ensure that discrete pixel perforations are achieved. Typically it is possible to make film perforations by this method having resolutions in the range from 200 to 600 holes per inch.

Laser perforation may be carried out by known methods, typically using a single beam or a low multiple from a high-power source, such as a CO₂ laser or YAG laser, for example. These methods require the laser beam to be pulsed and to be moved over the surface of the precursor film by such means as a galvanometric scanner, so that the energy pulse is delivered to its intended location. Apart from the low perforation rates which characterize these methods, the use of such high-power sources for perforating thin films tend to result in material ablation rather than in melting as the dominant process of hole formation. Consequently, the mass of the perforated film is lower than the mass of the precursor film. In contrast, hole formation by means of a melting process leads to the retention of the original film mass, with the melted material forming regions of increased thickness at the hole margins. Accordingly, films perforated by a melting process have a larger minimum cross-sectional area than corresponding films perforated by material ablation to form an otherwise equivalent perforation pattern. For thin films this difference may be crucial, since mechanical properties such as tensile strength and tensile modulus, for example, are a function of the minimum cross-sectional area.

A preferred laser method for perforating large areas of a thin film at economically viable rates, where melting is the sole or dominant process, is to use a semiconductor laser arrangement as the means of perforation.

Relatively low-power semiconductor laser arrangements are well known, for example, as components of xerographic copiers and printers. Recently, however, devices with increased power have become available, and we have been able to demonstrate that they are capable of perforating thin films. For metal foils, however, it is necessary to use high-energy gas lasers. In such devices, the laser arrangement typically possesses a series of semiconductor laser modules or chips, which provide a multiplicity of laser channels. By linking the modules to one another it is possible to create wide linear arrangements, which may be disposed transversely over a continuous film web, so that one laser channel is located over every point to be perforated when the film is moved underneath. A device of this kind avoids the problems of previous processes, involving a single laser beam or low number of laser beams, with the result that it is possible to achieve perforation of film webs on a large scale at linear speeds which are several orders of magnitude higher than hitherto possible.

By means of this kind it is possible to achieve laser resolutions of 200 channels per inch or more, with equivalent hole resolutions in the resulting perforated films. Lasers of this kind operate typically with shorter wavelengths, within the near infrared region (NIR region) of the electromagnetic spectrum. Typically, energies of individual laser channels of more than 200 mW can be achieved. For the purposes of this invention, lasers are selected on the basis of power, stability, and wavelength. In particular it is necessary to ensure that the film to be perforated is capable of absorbing energy at the operating wavelength of the laser. Since, in the case of polymeric films, many of these films are largely transparent within the NIR region, it is necessary to modify these films by provision of a coating in order to increase their absorption at the wavelength of the perforating laser, i.e., in the NIR region of the electromagnetic spectrum.

In one embodiment of this invention a polymeric film which exhibits little or no energy absorption of the wavelength of the perforating lasers is selectively coated or printed with a material in order to increase the absorption of energy at the laser wavelength. Consequently it is possible to carry out selective perforation of this film using laser arrangements with simple controls, which provide pulses of laser energy over the entirety of the available film surface. Through such means it is possible to generate selected perforation areas, such as patches or bands of perforation, for example, within the overall area of the film. An alternative possibility is to create decorative patterns or patterns which represent codes or logos for product security or identification.

An alternative means for selective perforation is to configure the laser arrangement in such a way that each laser channel can be addressed individually. In conjunction with suitable head driver software it is possible to create a very wide selection of perforation patterns within the limits of the laser channel resolution.

In another novel embodiment, an alternative process for perforation is achieved using a semiconductor laser arrangement where lenses are used in order to generate a continuous laser beam along the length of each module—a so-called “laser bar”. Such configurations are capable of attaining very high energy fluences. The perforation of films having little or no absorption at the operating wavelength of the perforating lasers can be achieved if the films are printed selectively with energy-absorbing dots of ink at those locations where perforation is required. Through this process it is possible to create a variety of hole shapes and hole sizes, determined by the shape and size of the printed dot of energy-absorbing ink. The dots may have substantially the same size—for example, a mean diameter of 10 to 125 μm. The laser arrangement and/or the film may be disposed in such a way as to achieve a relative movement between them both. For example, the laser arrangement may be disposed in such a way that a laser line is provided transversely over the film to be perforated, i.e., transversely to the length of the film. In that case the laser arrangement may be movable over the surface of the film and/or the film may be disposed in such a way as to move relative to the laser arrangement, which may be fixed.

This particular “laser bar” embodiment has a number of significant advantages:
1. In contrast to other laser processes, which would require changes to the head resolution and/or the provision of a complex head driver electronics and software system, it is very easy to change the size and position of perforations by changing the print pattern.
2. The use of NIR absorbers is minimized. This is an important consideration, since many absorbers are expensive and make a significant contribution to the overall costs of raw materials for the manufacture of perforated films.
3. It is possible to create perforated films with high transparency and low coloration even when using strongly colored and opaque absorbing inks. As a result of this approach, any residual ink is confined to the margin of the perforations, where melted material solidifies after perforation and therefore has minimal impact on the appearance of the perforated film of the invention.

The thin, perforated films of the present invention and their laminates can be used in various end applications, irrespective of whether these films or laminates are coated or uncoated, impregnated or not impregnated. The films of the present invention (whether in stand alone form or laminated) can be coated or impregnated with a variety of coating materials for a variety of purposes.

If the laminate of the invention is coated or impregnated with a ceramic material, i.e., after it has been perforated, this laminate may find specific use as a battery separator, possessing the advantageous properties of this type of media, which are described in the prior art.

The thin perforated films of the present invention, with or without nonceramic coating or whether impregnated or not, may likewise find use as battery separators.

The films of the invention may likewise find use as packaging material for defined atmospheres, electrochemical membrane or filter medium, or as battery separator, the film being optionally coated or impregnated with ceramic or nonceramic material.

In one particular embodiment, in which the film, coated or otherwise, is laminated to a porous substrate, it is possible to incorporate what is called a “shutdown layer”. This is a safety feature which prevents uncontrolled temperature increases resulting from overcharging, physical damage or internal effects. In a bilayer structure, such as a laminate formed from a microperforated film and a nonwoven, for example, it is possible to create a shutdown layer by selecting these components in such a way that one component provides mechanical strength and thermal stability and the other component provides the shutdown function by virtue of its relatively low melting point. In the event of a potentially catastrophic short circuit, causing the temperature within the battery to rise, the shutdown layer melts, and so the pores in the other component become blocked, thereby substantially halting ion flow within the battery cell and thus preventing a loss of thermal control. The shutdown layer typically has a melting point of 130° C. or less, as described in the prior art. In the present invention, the shutdown function may be achieved, for example, by selecting a polyethylene film as a component of the microperforated film, in conjunction with, for example, a synthetic nonwoven with polyester fibers (PET fibers) or polyester microfibers. Alternatively the shutdown function may be created by the use of a nonwoven with fibers having a low melting point, such as polyethylene fibers, for example, combined in a laminate with a microperforated film having a relatively high melting point, such as PET or PEN, for example.

The high level of perforation that may be achieved by the present invention makes the films useful for a number of other end applications, including their use as air-permeable packaging material, electrochemical membranes for use in a variety of applications, and disposable filter media.

In another embodiment, the present invention provides a battery which comprises as a battery separator a perforated polymeric film or a laminate of the type described above.

The invention therefore likewise provides a battery having a battery separator which is or comprises the perforated film of the invention or the laminate of the invention.

The perforated film or laminate of this battery may preferably be coated or impregnated with ceramic or nonceramic material.

The present invention is now further illustrated by the following examples.

### Example 1

A polyethylene terephthalate (PET) film having a nominal thickness of 6 μm was coated with a water-based ink containing a carbon pigment sold under the name Pacific Black® (available from Antonine Printing Inks Ltd.), to give a coating with a 1.0 g/m² dry weight, which is capable of absorbing light in the near infrared. The thickness of the coated film was approximately 7 μm.

The coated film was perforated using a semiconductor laser module which operated at 980 nm and was capable of a maximum fluence of 255 J/cm². The resulting perforated film had a series of very similar holes having a mean diameter of 50 μm. A cross-section of a typical perforation was analyzed by SEM (PHENOM, FEI company) and the resultant 3D images were analyzed. Table 1 shows the data obtained:

TABLE 1

| Position of raised margin | one side only (coated | |
|---|---|---|
| | side of the film) | |
| Maximum increase in film thickness at hole | 5.2 | μm (95%) |
| margin | | |
| Mean diameter of hole | 48.7 | μm |
| Mean diameter of raised margin | 62.83 | μm |
| Mean width of raised margin | 14.02 | μm |
| Calculated from these data: | | |
| Film volume occupied by perforated hole | 10 273 | μm³ |
| Margin volume assuming a semicircular cross- | 8375 | μm³ |
| section | | |

The volume of the melted polymer present as a raised margin around the hole therefore represents 82% of the polymer volume removed by formation of the hole.

### Comparative Example 2.1

### Examples 2.2 to 2.4

A series of perforated films was manufactured in accordance with the details in table 2 below, the perforated area being approximately 10 cm×10 cm. Films with PET polymer were Mylar C (DuPont Teijin Films). The mean hole diameter and the solid cross-sectional area were obtained from SEM images of the perforated film. The tensile strengths in comparative example 2.1 and in example 2.2 were measured directly on the basis of the method of ASTM D882, using a tensile strength tester (Zwick Z2.5/TN1S), which operated at an elongation rate of 50 mm/min, using samples of the films with a width of 20 mm and a clamped-in length of 40 mm (100 mm specimen length) between the attachment points.

The tensile strengths for the other examples were determined by calculation, the tensile strength being taken to be 209 N/mm², the value for the PET film in accordance with ASTM D882, taking account of the solid cross-sectional area of the unperforated precursor films.

A ceramic coating mix was prepared from 4500 ml of a 10% strength solution of polyvinylidene fluoride/hexafluoropropylene copolymer (Kynar Flex 2801, Arkema), to which a mixture of 55% by weight of aluminum oxide (CT3000 Alcoa) and acetone was added, to which 4 g of nitric acid had been added. The mixture was stirred with a paddle stirrer for 1 hour at 300 rpm. The mixture was subsequently subjected to an ultrasound treatment (Hielscher UP 400S) for approximately 2 hours, until the maximum particle size did not exceed 10 μm.

The samples of the perforated film of the invention were prepared for coating such that they had an individual perforated area (10 cm×10 cm) with an unperforated margin of at least 15 mm on each side. Each of the perforated films was coated by being immersed manually into the coating mixture. Through this process, the coating mixture impregnated the pores and adhered to both areas of the film. On withdrawal from the coating mixture, the coated film was suspended vertically, to allow excess mixture to drip off, and was dried at room temperature for 12 hours, to give a porous resin medium. Furthermore, a continuous film, provided piecewise with perforated areas measuring 10 cm×10 cm, was coated continuously with the stated ceramic dispersion in a roll-coating process, then dried and rewound.

On completion of the drying process, inventive films from examples 2.2 to 2.4 remained completely flat and were subsequently incorporated as separators into lithium batteries. It was found that they enabled batteries which have a comparable power, in which the separator had a ceramic coating on a nonwoven carrier medium. In contrast, it was not possible to handle the film obtained in comparative example 2.1 either as an individual sheet or in the form of roll product. On account of the distortion and cracking, it was not possible to wind the material or to provide it with a uniform coating. Consequently, this material could not be used as a battery separator, since the lack of flatness prevented complete contact with the battery electrodes.

TABLE 2

| | Example | | | |
|---|---|---|---|---|
| | 2.1 | | | |
| | (comparative example) | 2.2 | 2.3 | 2.4 |
| Film polymer | Blend of PET and PET | PET | PET | Coated PET^{[1]} |
| | copolymer | | | |
| Film thickness (μm) | 2.5 | 6.0 | 6.0 | 7.0 (6.0 μm film plus |
| | | | | coating) |
| Perforation process | Thermal printing head | CO₂ laser | CO₂ laser | CO₂ laser |
| Mean hole diameter (μm) | 60 | 93 | 121 | 123 |
| Cross-sectional area % | 25 | 55 | 42 | 39 |
| continuous film | | | | |
| Tensile strength (N/cm) | 0.9 | 5.9 | 5.2 | 5.6 |
| Winding quality | Winding not possible | No problems | No problems | No problems |
| Appearance after | wavy | flat | flat | flat |
| application of porous | | | | |
| ceramic coating | | | | |
| Use in battery | unusable | functioning | functioning | functioning battery |
| | | battery | battery | |

^{[1]}Note: Resin coating comprising carbon pigment.

### Example 3

A perforated film based on a metal foil, available commercially, for example, from Aldi, with a thickness of 200 μm, was manufactured, the perforated area being approximately 10 cm×10 cm. The mean hole diameter was 200 μm, with a hole fraction of approximately 10%. The tensile strength was measured as in comparative example 2.1 and in example 2.2.

The inventive film had a tensile strength of 31 N/cm and, with these properties, was very amenable to winding and coating, without any defects or conspicuities being observed.

1. A perforated film, having:
a thickness of less than 20 μm;
a tensile strength of 2 N/cm to 40 N/cm; and
a hole area of 10% to 90%.

2. The perforated film of claim 1, having a thickness of up to 15 μm.

3. The perforated film of claim 1, having a weight in a range from 40% to 100% of a weight of an equivalent unperforated film.

4. The perforated film of claim 1, comprising perforation holes having a mean diameter in a range from 50 to 250 μm.

5. The perforated film of claim 1, is comprising a material which absorbs in the near infrared, wherein the perforated film only perforated in an area printed with the material.

6. The perforated film of claim 1, wherein the perforated film is obtained by perforating a film with an input of laser radiation.

7. The perforated film of claim 1, comprising perforations each of which have a raised margin at a periphery that is greater in thickness than an unperforated region of the perforated film.

8. The perforated film of claim 7, comprising a material which absorbs in the near infrared and is present in the raised margins of the perforations, wherein the material is absent from a region between the perforations.

9. The perforated film of claim 1, comprising:
a thermoplastic polymer film selected from the group consisting of a polyester, a polypropylene, a polyethylene terephthalate, a polyethylene naphthenate, a polylactic acid, a polyacrylonitrile, a polyamide, a polymethyl methacrylate, a polyimide, and an aromatic polyamide; or
a metal foil.

10. The perforated film of claim 9, comprising a polyester or a polyamide film.

11. The perforated film of claim 9, a metal foil, wherein the metal is selected from the group consisting of Si, Al, Cu, and Fe.

12. The perforated film of claim 4, wherein the perforation holes are substantially circular.

13. The perforated film of claim 1, comprising a ceramic coating.

14. The perforated film of claim 1, comprising a ceramic or nonceramic material impregnated therein.

15. A packaging material, electrochemical membrane, or filter medium, comprising the perforated film of claim 1.

16. A battery separator, comprising the perforated film of claim 1, wherein the perforated film is optionally coated or impregnated with ceramic or nonceramic material.

17. A laminate, comprising:
the perforated film of claim 1; and
a porous medium the perforated film is laminated,
wherein the laminate has a tensile strength of 2 to 50 N/cm.

18. The laminate of claim 17, wherein the perforated film has a thickness of less than 20 μm and a hole area of 10% to 85%.

19. The laminate of claim 17, wherein the porous medium is a nonwoven.

20. The laminate of claim 17, wherein the porous medium is removable.

21. The laminate of claim 17, wherein the perforated film comprises a thermoplastic polymer.

22. The laminate of claim 21, wherein the thermoplastic polymer is selected from the group consisting of a polyester, a polyethylene terephthalate, a polyethylene naphthenate, and a polyamide.

23. The laminate of claim 17, wherein
a) the perforated film has a lower melting point than the porous medium, which is not more than 250° C.
or
b) the porous medium has a lower melting point than the perforated polymeric film, which is not more than 250° C.

24. The laminate of claim 17, further comprising:
a ceramic or nonceramic material, wherein the ceramic or nonceramic material is a coating or impregnated therein.

25. A battery, comprising a battery separator comprising the laminate of claim 17.

26. A battery, comprising a battery separator comprising the perforated film of claim 1.

27. The battery of claim 26, wherein the perforated film comprises a ceramic or nonceramic material, which is a coating or impregnated therein.

28. The battery of claim 25, wherein the laminate further comprises ceramic or nonceramic material, which is a coating or impregnated therein.
